(19) United States
(12) Patent Application Publication
(10) Pub. No.: US 2003/0110308 A1
(43) Pub. Date: Jun. 12, 2003

(54) Fast socket technology implementation using doors

(75) Inventors: Nagendra Nagarajayya, Sunnyvale, CA (US); Sathyamangalam Ramaswamy Venkatramanan, Cupertino, CA (US); Ezhilan Narasimhan, Cupertino, CA (US)

Correspondence Address: David B. Ritchie, Thelen Reid & Priest LLP, P.O. Box 640640, San Jose, CA, 95164-0640, US

(73) Assignee: Sun Microsystems Inc., a California Corporation

(21) Appl. No.: 09/991,604

(22) Filed: Nov. 21, 2001

(51) Int. Cl. G06F 9/46; G06F 9/00

(52) U.S. Cl. 709/313; 709/328

(57) ABSTRACT

A method moves data between processes in a computer-based system. Each process calls for one or more symbols in a first library. A second library comprises one or more equivalent symbols with Fast Sockets technology having a door interprocess communication mechanism. The call for a symbol in the first library from each process is intercepted and redirected to a corresponding symbol in the second library.

### CROSS REFERENCES

The present application is related to co-pending application entitled “Fast Socket Technology Implementation using Memory Mapped Files and Doors” by inventors Nagendra Nagarajayya, Sathyamangalam Ramaswamy Venkatramanan, Ezhilan Narasimhan (attorney docket number SUN-P6304). The present application is also related to co-pending application entitled “Fast Socket Technology Implementation using Memory Mapped Files and Semaphores” by inventors Nagendra Nagarajayya, Sathyamangalam Ramaswamy Venkatramanan, Ezhilan Narasimhan (attorney docket number SUN-P6305) all commonly owned herewith.

### FIELD OF THE INVENTION

The present invention relates to interprocess communication. More particularly, the present invention relates to interprocess communication utilizing an interposition technique.

### BACKGROUND OF THE INVENTION

Interprocess communication (IPC) is the exchange of data between two or more processes. Various forms of IPC exists: pipes, sockets, shared memory, message queues, and Solaris™ doors.

A pipe provides the ability for a byte of data to flow in one direction and is used between processes. These two processes must be of common ancestry. Typically, a pipe is used to communicate between two processes such that the output of one process becomes the input of another process. FIG. 1 illustrates a conventional pipe 100 according to a prior art. The output of process 102 becomes the input of process 104. Pipe 100 is terminated when process 102 that is referencing it terminates. Data is moved from process 102 to process 104 through a pipe 100 situated within a kernel 106.

A socket is another form of IPC. It is a network of communications endpoints. FIG. 2 illustrates sockets 200 and 202 according to a prior art. A process 204 communicates with another process 206 through a couple of sockets 200 and 202 via a kernel 208. The advantages of sockets include high data reliability, high data throughput, and variable message sizes. However these features require a high setup and maintenance overhead, making the socket technique undesirable for interprocess communications on the same machine. The data availability signal 210 is transmitted through the kernel 208. Applications using sockets transfer data call a read function 212 and a write function 214. These calls make use of the kernel 208 to move data by transferring it from the user space to the kernel 208, and from the kernel 208 back to the user space, thus incurring system time. Though this kernel dependency is necessary for applications communicating across a network, it impacts system performance when used for communication on the same machine.

Shared memory is another form of IPC. FIG. 3 illustrates the use of a shared memory 300 to communicate process 302 with process 304. Shared memory is an IPC technique that provides a shared data space that is accessed by multiple computer processes and may be used in combination with semaphores. Shared memory allows multiple processes to share virtual memory space. Shared memory provides a quick but sometimes complex method for processes to communicate with one another. In general, process 302 creates/allocates the shared memory segment 300. The size and access permissions for the segment 300 are set when the segment 300 is created. The process 304 then attaches the shared memory segment 300, causing the shared segment 300 to be mapped into the current data space of the process 304. (The actual mapping of the segment to virtual address space is dependent upon the memory management hardware for the system.) If necessary, the process 302 then initializes the shared memory 300. Once created, other processes, such as process 304, can gain access to the shared memory segment 300. Each process maps the shared memory segment 300 into its data space. Each process accesses the shared memory 300 relative to an attachment address. While the data that these processes are referencing is in common, each process will use different attachment address values. Locks are often used to coordinate access to shared memory segment 300. When process 304 is finished with the shared memory segment 300, process 304 can then detach from the shared memory segment 300. The creator of the memory segment 300 may grant ownership of the memory segment 300 to another process. When all processes are finished with the shared memory segment 300, the process that created the segment is usually responsible for removing the shared memory segment 300. Using shared memory, the usage of kernel 306 is minimized thereby freeing the system for other tasks.

The fastest form of IPC on Solaris™ Operating System from Sun Microsystems Inc. is doors. However, applications that want to communicate using doors need to be explicitly programmed to do so. Even though doors IPC is very fast, the socket-based IPC is more popular since it is portable, flexible, and can be used to communicate across a network.

A definite need exists for a fast IPC technology that would overcome the drawbacks of doors and socket-based IPC. Specifically, a need exists for a fast socket technology implementation using doors. A primary purpose of the present invention is to solve these needs and provide further, related advantages.

### BRIEF DESCRIPTION OF THE INVENTION

A method moves data between processes in a computer-based system. Each process calls for one or more symbols in a first library. A second library comprises one or more equivalent symbols with Fast Sockets technology having a door interprocess communication mechanism. The call for a symbol in the first library from each process is intercepted and redirected to a corresponding symbol in the second library.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating an interprocess communication using pipes according to a prior art;

FIG. 2 is a block diagram illustrating an interprocess communication using sockets according to a prior art;

FIG. 3 is a block diagram illustrating an interprocess communication using a shared memory according to a prior art;

FIG. 4 is a block diagram illustrating an interprocess communication using the Speed Library according to a specific embodiment of the present invention;

FIG. 5 is a flow diagram illustrating a method for moving data between processes according to a specific embodiment of the present invention; and

FIG. 6 is a block diagram illustrating a memory describing an interprocess communication using the Speed Library according to a specific embodiment of the present invention.

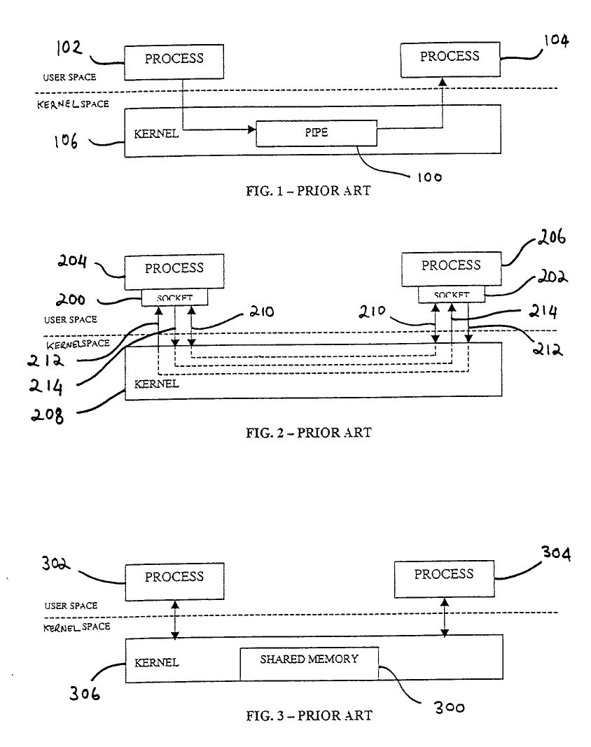

### DETAILED DESCRIPTION

Embodiments of the present invention are described herein in the context of a method and apparatus for emulating web browser proxies. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Doors are a mechanism for communication between computer processes (IPC) on the same machine. In general, a door is a portion of memory in the kernel of an operating system that is used to facilitate a secure transfer of control and data between a client thread of a first computer process and a server thread of a second computer process.

The present invention uses a Speed Library to interpose socket calls with Speed Library calls associated with doors. In particular, the interposition technique is used to dynamically overlay INET-TCP sockets. The Speed Library design is based on the principle that minimizing system time translates directly to a gain in application performance.

The present invention relies on the concept of interposition of dynamic shared library symbols. For example, in an operating system, dynamic libraries allow a symbol to be interposed so that if more than one symbol exists, the first symbol takes precedence over all other symbols. Any function call an application makes to any dynamic shared library can be intercepted.

To use library interposition, a dynamic shared library needs to be created. For example, in the Solaris Operating System, when LD_PRELOAD environment variable is set, the dynamic linker will use the specified library before any other when it searches for shared libraries. Thus, the environment variable LD_PRELOAD can be used to load shared objects before any other dependencies are loaded. The Speed Library uses this concept to interpose functions that will be discussed in more details below.

Speed Library interposition is needed on both the server and the client applications. This interposition allows existing client-server applications to transparently use the library. For example, on the server side, LD_PRELOAD may be used to load the shared library LIBSPEEDUP_SERVER.SO. On the client side, LD_PRELOAD may be used to load LIBSPEEDUP_CLIENT.SO.

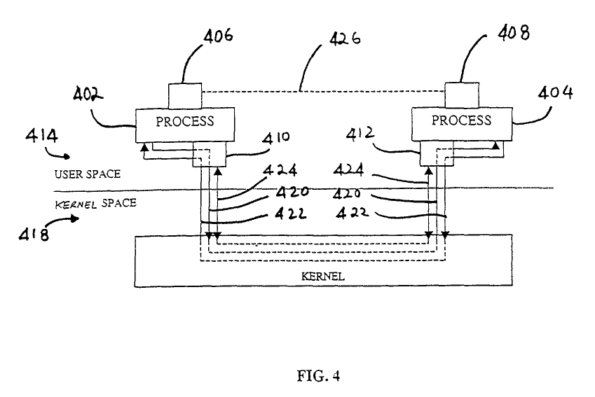

FIG. 4 is a block diagram illustrating an interprocess communication (IPC) using a Speed Library according to a specific embodiment of the present invention. A process 402 communicates with another process 404. Each process 402, 404 opens a TCP socket 406, 408 respectively, which is associated with a socket library (not shown). Through interposition, process calls for the socket library are intercepted and redirected to the Speed Library (not shown) that is associated with a door IPC mechanism. The Speed Library enables process 402 to communicate with process 404 via doors 410 and 412 respectively. Both processes 402 and 404 are represented in the system space 414 while a kernel 416 is represented in the system space 418.

For example, process 402 calls a write function (represented by arrow 420 ) to send data to process 404. The write call is transformed through interposition with the Speed Library into door calls 400 and 412. Process 402 calls a read function (represented by arrow 422 ) to read data from process 402. The read call is transformed through interposition with the Speed Library into door calls 410 and 412. The synchronization signals (represented by arrows 424 ) traveling through doors 410 and 412, signal processes 402 and 404, the data availability. The sockets 406 and 408 virtually communicate (represented by line 426 ) while the data and synchronization signals are actually transferred through the doors 410 and 412 enabled by the Speed Library.

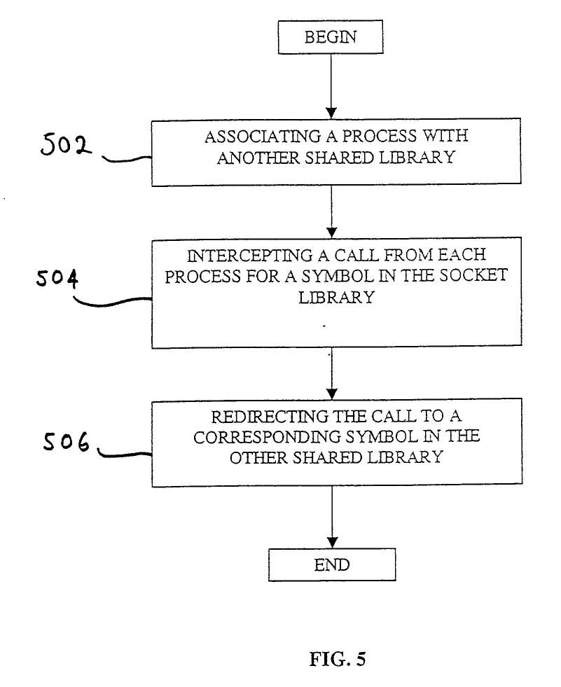

FIG. 5 is a flow diagram illustrating a method for moving data between processes according to a specific embodiment of the present invention. In a first block 502, a second shared library, such as a Speed Library, is associated with a process through interposition. In block 504, a process call for a symbol in a first library, for example a TCP socket library, is intercepted by the interposer. The interposer in turn redirects the call for a corresponding symbol in the second shared library in block 506. Even tough the symbols are interposed, the TCP socket client-server semantics are not changed. Data and synchronizing signals are exchanged between processes. For example, a server process establishes a server socket and listens on this socket. The client process connects to this port to establish a connection, starts reading and writing information as usual. But instead of flowing through the socket, the data is transferred using the doors IPC.

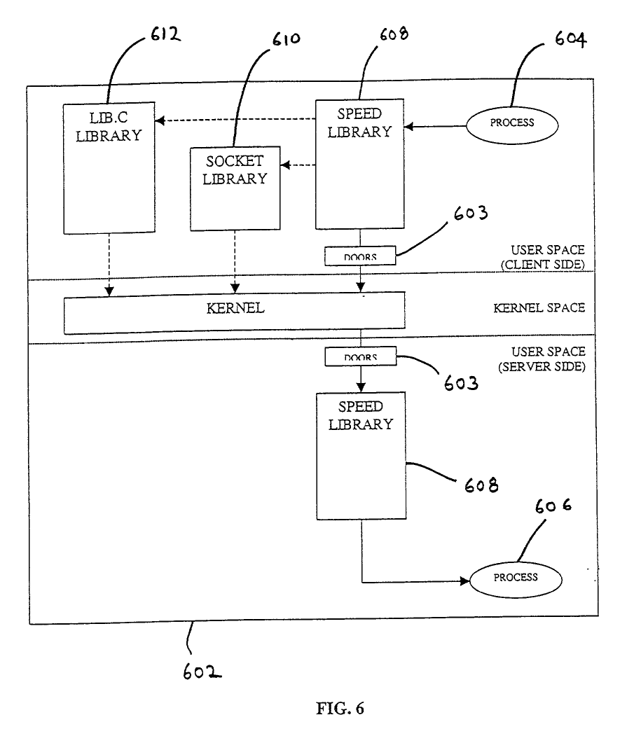

FIG. 6 illustrates a memory for moving data between processes according to a specific embodiment of the present invention. A memory 602 comprises several processes, for example processes 604 and 606, a Speed Library 608, a socket library 610, a lib.c library 612, and a kernel 614. Calls from process 604 for symbols in socket library 610 or the lib.c library 612 are intercepted by the speed library 608. The speed library 608 interposes the calls from process 604 redirects the calls for symbols to corresponding symbols in speed library 608. The speed library 608 comprises a list of symbols enabling process 604 to communicate with process 606 through the doors 603 IPC mechanism. The data and synchronization data are transmitted through the doors through kernel 614 belonging to the kernel space.

In the user space, on the client side, the speed library 608 however redirects the calls from process 604 either to the socket library 6 10 or the lib.c library 612 depending on whether the speed library 608 can handle the calls. For example, the speed library 608 redirects calls to the socket library 6 10 for file descriptors that are associated with remote sockets (to and from other host). The speed library 608 also redirects calls to the lib.c library 612 for any file descriptor not associated with a socket. The redirected calls to either the lib.c library 612 and the socket library 610 enable process 604 to communicate with process 606 through the kernel 603 in the kernel space. The data and synchronization data are transmitted through their respective library to the process 606. For example, when process 604 calls for a remote socket in socket library 610, the data communicates through the socket library 610, the kernel 614, and back the socket library 610, and finally to process 606.

Because threads in two different processes need to be synchronized to send and receive data, a producer/consumer paradigm is used to transfer data. In transferring data from the client to the server, a write operation by the client is a read operation in the server. In other words, the client becomes the producer and the server becomes the consumer. The roles are reversed when transferring data from the server to the client, in which case the server becomes the producer and the client becomes the consumer.

Once a server socket has been created, it is named with a call to the BIND function. Since LIBSPEEDLIB_SERVER.SO is interposed on the server side, the Speed Library BIND function is called first. That is, the Speed Library establishes the doors service first and then calls the original socket BIND.

The following illustrates an example of a code for a server side BIND function of the Speed Library:

int bind(int s, const struct sockaddr*addr,

socklen_t addrlen)

{

| int did; | |
|---|---|
| pid_t id; | |
| int dfd,dfd1; | |
| int mask; | |
| static int(*fptr)( ) = 0; | |
| char | buffer[50]; |
| char | *bptr=buffer; |

if (fptr == 0) {

struct sockaddr_in *ad = (struct

sockaddr_in*)addr;

if ((did = door_create(server,

DOOR_COOKIE, DOOR_UNREF)) < 0) {

perror(“door_create”);

return −1;

}

[Step 1] unlink(NAME_SERVICE_DOOR);

mask = umask(0);
dfd = open(NAME_SERVICE_DOOR,

O_RDONLY|O_CREAT|O_EXCL|O_TRUNC,
0644);

umask(mask);
if (fattach(did, NAME_SERVICE_DOOR)

< 0) {

perror(“fattach”);
return −1;

}

[Step 2] fptr = (int (*)( ))dlsym(RTLD_NEXT,

“bind”);

if (fptr == NULL) {

(void) printf(“dlopen: %s\n”,

dlerror( ));

return (0);

}

}

[Step 3] return ((*fptr)(s, addr, addrlen));
}

In step 1, the BIND function is used to establish a door service. In step 2, a DLSYM lookup is performed to obtain the actual address of the BIND function in LIBSOCKET.SO which is actually stored in the static variable FPTR and used for chaining to the actual BED function. In step 3, the BIND function in LIBSOCKET.SO is called to establish the name.

The ACCEPT function on the server side is used to accept an incoming client connection request. On a CONNECT request, the Speed Library ACCEPT is called since it interposes the LIBSOCKET.SO's ACCEPT. The Speed Library first calls the LIBSOCKET.SO ACCEPT to actually create a TCP connection. Once a successful connection has been established, the socket descriptor is stored in a Speed data structure, and synchronization variables are initialized.

The READ function on the server side is a consumer of the client-write data. When the server tries to read data on a file descriptor, the Speed Library READ function is called because it is interposed. A check is made to see whether the file descriptor matches the established file descriptor. If so, the READ function waits on the semaphore OCCUPIED_R. For all other file descriptors, the Speed Library function transfers control to the LIBC.SO READ in the socket library.

When the client writes some data, the data is transferred using doors IPC into the server process. The doors service in the server process identifies whether the operation is a read or write. A sema_wait operation is executed on the empty_r semaphore, and a sema_post is executed on occupied_r. The sema_post wakes up the read thread. The read thread copies the data using bcopy and wakes up the door service thread using sema_post on the empty_r semaphore.

The following illustrates an example of a code for a server side READ function of the Speed Library:

door_service(void *cookie, char *argp, size_t arg_size,

door_desc_t*dp, uint_t n_descriptors)

{
. . .

} else if (ptr->type == WRITE) {

[Step 1] fd = ports[ptr->port];

SEMA_WAIT(&pmap[fd].empty_r);

[Step 2] bcopy(ptr->buf, pmap[fd].rbuf, ptr->size);

sema_post(&pmap[fd].occupied_r);

}

. . .
}

In step 1, the READ function verifies that the operation is a client WRITE. It then copies the port it is communicating on and sends it through the door call. A sema_wait is executed to see if there is space in the Speed data buffer (producer). In step 2, bcopy copies data from door buffer to the Speed data buffer. A sema_post is executed to signal the Speed server side READ that data is available.

read(int fildes, char* buf, size_t nbyte)
{
. . .
[Step 1] if (fildes > 0 && pmap[fildes].fd == fildes) {
[Step 2] SEMA_WAIT(&pmap[fildes].occupied_r);

bcopy(pmap[fildes].rbuf, buf, nbyte);
sema_post(&pmap[fildes].empty_r);
return nbyte;

}

. . .
}

In step 1, the function checks for a valid file descriptor and sees whether it exists in the Speed data structure, i.e., a valid socket descriptor. In step 2, a sema_wait is executed to see if data exists in the Speed data buffer to read (consumer). If successful, bcopy is used to copy the data from the speed data structure to the application buffer. A sema_post is executed to signal the producer (client) that the data has been read.

The WRITE function on the server side is a producer of the client-read data. When the server tries to WRITE data on a file descriptor, the Speed function WRITE is called since it is interposed. A check is first made to see whether the file descriptor matches the established connection file descriptor, and, if so, the WRITE function waits on the semaphore empty_w. Otherwise, the file descriptor is transferred to the WRITE function of socket library. If successful, the data is copied to the Speed buffer and sema_post is executed on occupied_w.

When the client tries to read data, a fast context switch occurs into the server process using doors IPC. The doors service in the server process identifies if the operation is a read or write, and a sema_wait operation is executed on the occupied_w semaphore. The sema post on occupied_w by the write thread allows the door_service thread, and the data in the Speed buffer is transferred to the client-read buffer. A sema_post is then executed on the empty_w semaphore.

The following illustrates an example of a code for a server side WRITE function of the Speed Library:

ssize_t write(int fildes, const void *buf, size_t nbyte)
{
. . .

if (fildes > 0 && pmap[fildes].fd == fildes) {

[Step 1] SEMA_WAIT(&pmap[fildes].empty_w);
[Step 2] bcopy(buf, pmap[fildes].wbuf, nbyte);

sema_post(&pmap[fildes].occupied_w);
return nbyte;

}
. . .
}

In step 1, a sema_wait is executed to see whether there is space in the Speed data buffer (producer). In step 2, bcopy copies data from the application buffer to the Speed data buffer. A sema_post is then executed to signal door_service that data is available.

door_service( void *cookie, char *argp, size_t arg_size,

door_desc_t*dp, uint_t n_descriptors)

{
. . .
if (ptr->type == READ) {
[Step 1] fd = ports[ptr->port];

SEMA_WAIT(&pmap[fd].occupied_w);

[Step 2] bcopy(pmap[fd].wbuf, ptr->buf, ptr->size);

sema_post(&pmap[fd].empty_w);
door_return((char*)ptr->buf, ptr->size, NULL, 0);

}

. . .
}

In step 1, the client should have executed a read call asking for data. Door_call is executed for a fast context switch to server address space. Sema_wait is executed to see whether there is data in the speed data buffer. In step 2, if successful, bcopy copies the data from the speed data structure to the door buffer. A sema_post is executed to signal the producer (server) that data has been read.

The client establishes a connection to the server using the CONNECT function. Since the CONNECT symbol is interposed, the Speed version of CONNECT gets control. A connection is established to the server using the doors IPC. The libsocket.so connect is called to establish a real connection. If the connection is successful, the data structures in the Speed Library are initialized.

The following illustrates an example of a code for a client side CONNECT function of the Speed Library:

int connect(int s, const struct sockaddr *addr, socklen_t addrlen)
{
. . .
[Step 1]if (fptr == 0) {

if ((door_fd=open(NAME_SERVICE_DOOR,
O_RDONLY)) < 0) {

perror(“Open bogus”), exit(1);

}
info.di_target=0;
if (door_info(door_fd, &info) < 0 ){

perror(“Door_info”);
printf(“errno=%d\n”, errno);

exit(1);
}
fptr = (int (*)( ))dlsym(RTLD_NEXT, “connect”);
if (fptr == NULL) {

(void) printf(“dlopen: %s\n”, dlerror( ));
return (0);

}

}

[Step 2]dinfo[s].fd = s;

ret = ((*fptr)(s, addr, addrlen));

| | |
|---|---|
| [Step 3] | if (ret != −1) { |
| | slen = sizeof(client); |
| | getsockname(s, (struct sockaddr *)&client, &slen); |
| | dinfo[s].port = client.sin_port; |

}
return ret;

}

In step 1, a connection is established using doors. In step 2, the libsocket.so connect is called to establish a real connection. If the connection is successful, the data structures in the Speed Library are initialized in step 3.

When the client calls READ to get data from the server, the Speed version of READ is called. A check is made to ensure that the file descriptor matches the established connection. A fast context switch is then made into the server door_service. On return, the server data is copied into the client buffer using bcopy.

The following illustrates an example of a code for a client side READ function of the Speed Library:

ssize_t read(int fildes, void *buf, size_t nbyte)
{
. . .
[Step 1]if (dinfo[fildes].fd > 0 && dinfo[fildes].fd == fildes) {

dinfo[fildes].port));

| | dinfo[fildes].read.fd=dinfo[fildes].fd; |
|---|---|
| | dinfo[fildes].read.port=dinfo[fildes].port; |
| | dinfo[fildes].read.buf[0] = ‘\0’; |
| | dinfo[fildes].read.size=nbyte; |
| | dinfo[fildes].read.type=READ; |
| | dinfo[fildes].darg_r.data_ptr = (char*)&dinfo[fildes].read; |
| | dinfo[fildes].darg_r.data_size = PALDSIZE + nbyte + 1; |
| | dinfo[fildes].darg_r.desc_ptr = NULL; |
| | dinfo[fildes].darg_r.desc_num = 0; |
| | dinfo[fildes].darg_r.rbuf = (char*)dinfo[fildes].read.buf; |
| | dinfo[fildes].darg_r.rsize = nbyte; |
| | door_call(door_fd, &dinfo[fildes].darg_r); |
| [Step 2] | bcopy(dinfo[fildes].read.buf, buf, nbyte); |
| | return nbyte; |

}

. . .
}

In step 1, the function checks for a valid file descriptor and then performs a fast context switch into the server door_service. In step 2, the server data are copied into the client buffer using bcopy.

When the client calls WRITE to send data to the server, the Speed WRITE is called. A check is made to ensure that the file descriptor matches the established connection. If so, the WRITE data is copied using bcopy to a Speed buffer. A fast context switch is also performed into the server door_service to wake up the waiting server READ thread. If the file descriptor is invalid, the control is transferred to the READ function of the lib.c library or socket library.

The following illustrates an example of a code for a client side WRITE function of the Speed Library:

ssize_t write(int fildes, const void *buf, size_t nbyte)
{
. . .
[Step1]if (dinfo[fildes].fd > 0 && dinfo[fildes].fd == fildes) {

| | bcopy(buf, dinfo[fildes].write.buf, nbyte); |
|---|---|
| | dinfo[fildes].write.fd=dinfo[fildes].fd; |
| | dinfo[fildes].write.port=dinfo[fildes].port; |
| | dinfo[fildes].write.size=nbyte; |
| | dinfo[fildes].write.type=WRITE; |
| | dinfo[fildes].darg_w.data_ptr = (char *)&dinfo[fildes].write; |
| | dinfo[fildes].darg_w.data_size = PADSIZE + nbyte + 1; |
| | dinfo[fildes].darg_w.desc_ptr = NULL; |
| | dinfo[fildes].darg_w.desc_num = 0; |
| | dinfo[fildes].darg_w.rbuf = (char*)dinfo[fildes].write.buf; |
| | dinfo[fildes].darg_w.rsize = nbyte; |
| | door_call(door_fd, &dinfo[fildes].darg_w); |
| [Step2] | return nbyte; |

}

. . .
}

In step 1, the function checks for a valid first descriptor. In step 2, the server data are copied into the client buffer using bcopy.

The Speed Library has no protocol overhead. So the connection set up time is minimal, and READ and WRITE calls are converted into BCOPY calls. Since BCOPY calls is a user-level call, kernel usage (system time) is limited to signaling data availability. Test data shows that elapsed time with the Speed library is in fact the sum of bcopy times plus a very small amount of system time, thus approaching the ideal way to move data between two processes. The doors are used for synchronization and fast context switching. The data is still copied from the producer to the Speed buffer and from the Speed buffer to the consumer.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for moving data between processes in a computer-based system, each process calling for one or more symbols in a first library, the method comprising:
associating each process with a second library, said second library comprising one or more symbols with a door interprocess communication mechanism;
intercepting a call from each process for a symbol in said first library; and
redirecting said call to a corresponding symbol in said second library.

2. A method according to claim 1 wherein said first library comprises one or more symbols associated with a socket interprocess communication mechanism.

3. A method according to claim 1 wherein said associating further comprises dynamically linking each process with said second library.

4. A method according to claim 1 wherein said second library enables each process to communicate a synchronization signal through a door, said door enabled by said door interprocess communication mechanism.

5. A method according to claim 4 wherein said second library enables each process to transfer data through said door based on said synchronization signal.

6. A method according to claim 1 wherein said second library comprises one or more server-side symbols and one or more client-side symbols.

7. A method according to claim 6 wherein said server-side symbols further comprise a bind symbol, an accept symbol, a read symbol, a write symbol, and a close symbol.

8. A method according to claim 6 wherein said client-side symbols further comprise a connect symbol, a read symbol, a write symbol, a close symbol, and a thread_create symbol.

9. A program storage device readable by a machine, tangibly embodying a program of instructions readable by the machine to perform a method for moving data between processes in a computer-based system, each process calling for one or more symbols in a first library, the method comprising:
associating each process with a second library, said second library comprising one or more symbols with a door interprocess communication mechanism;
intercepting a call from each process for a symbol in said first library; and
redirecting said call to a corresponding symbol in said second library.

10. The program storage device according to claim 1 wherein said first library comprises one or more symbols associated with a socket interprocess communication mechanism.

11. The program storage device according to claim 9 wherein said associating further comprises dynamically linking each process with said second library.

12. The program storage device according to claim 9 wherein said second library enables each process to communicate a synchronization signal through a door, said door enabled by said door interprocess communication mechanism.

13. The program storage device according to claim 12 wherein said second library enables each process to transfer data through said door based on said synchronization signal.

14. The program storage device according to claim 9 wherein said second library comprises one or more server-side symbols and one or more client-side symbols.

15. The program storage device according to claim 14 wherein said server-side symbols further comprise a bind symbol, an accept symbol, a read symbol, a write symbol, and a close symbol.

16. The program storage device according to claim 14 wherein said client-side symbols further comprise a connect symbol, a read symbol, a write symbol, a close symbol, and a thread_create symbol.

17. An apparatus for moving data between process in a computer-based system, the apparatus comprising:
a plurality of processes;
a first library of symbols having one or more symbols, said plurality of processes calling for said one or more symbols in said first library of symbols;
a second library of symbols having one or more symbols, said one or more symbols associated with a door interprocess communication mechanism; and
an interposer intercepting a call for one or more symbols in said first library of symbols and redirecting a corresponding call for one or more symbols in said second library of symbols.

18. The apparatus according to claim 17 wherein said first library of symbols comprises one or more symbols associated with a socket interprocess communication mechanism.

19. The apparatus according to claim 17 wherein each process is dynamically linked with said second library of symbols.

20. The apparatus according to claim 17 wherein each process communicates a synchronization signal through a door, said door enabled by said door interprocess communication mechanism.

21. The apparatus according to claim 20 wherein data transfer through said door based on said synchronization signal.

22. The apparatus according to claim 17 wherein said second library further comprises one or more server-side symbols and one or more client-side symbols.

23. The apparatus according to claim 22 wherein said server-side symbols further comprise a bind symbol, an accept symbol, a read symbol, a write symbol, and a close symbol.

24. The apparatus according to claim 22 wherein said client-side symbols further comprise a connect symbol, a read symbol, a write symbol, a close symbol, and a thread_create symbol.

25. An apparatus for moving data between processes in a computer-based system, each process calling for one or more symbols in a first library, the apparatus comprising:
means for associating each process with a second library, said second library comprising one or more symbols with a door interprocess communication mechanism;
means for intercepting a call from each process for a symbol in said first library; and
means for redirecting said call to a corresponding symbol in said second library.
